(19) United States
(12) Patent Application Publication
(10) Pub. No.: US 2026/0234912 A1
(43) Pub. Date: Aug. 13, 2026

(54) MICROTRENCHER SAW TEETH FOR CUTTING COBBLE

(71) Applicant: McCown Technology Corporation, Lake Point, UT (US)

(72) Inventor: James C. McCown, Lake Point, UT (US)

(73) Assignee: McCown Technology Corporation, Lake Point, UT (US)

(21) Appl. No.: 19/320,830

(22) Filed: Sep. 5, 2025

Related U.S. Application Data
(60) Provisional application No. 63/691,938, filed on Sep. 6, 2024.

(51) Int. Cl. E02F 9/28; B28D 1/12; E02F 5/08

(52) U.S. Cl. CPC E02F 9/285; B28D 1/122; E02F 5/08

(57) ABSTRACT

Systems and apparatus for improved cutting of microtrenches. In a first illustrative embodiment, a tooth for use on a disk shaped microtrenching saw blade has a body with a hardened front or cutting face. Series of superhard cutting elements are disposed along opposite side edges of the front face and one or more superhard cutting elements may be disposed along the upper edge, such that as the saw blade is rotated, the ground being cut by the tooth is initially contacted by the cutting elements prior to the remainder of the face. In some embodiments, the upper edge of the front face may be inset at each side from the lateral edge of the face, such that the upper edge has a narrower cutting area with superhard cutting elements disposed thereacross. The present disclosure also includes embodiments of microtrenching saw blades including these novel teeth.

### CROSS-REFERENCE TO RELATED APPLICATION

This application claims the benefit of U.S. Provisional Application No. 63/691,938, filed Sep. 6, 2024, the disclosure of which is incorporated herein by reference in its entirety.

### TECHNICAL FIELD

The present invention relates generally to systems and apparatus for cutting microtrenches with ground cutting machinery.

### BACKGROUND

Microtrenchers use a circular, or disk shaped, saw blade with “teeth” containing superhard cutting elements to produce a narrow trench for the placement of utility lines, such as fiber optic cable, especially in locations with preexisting infrastructure. As depicted in FIGS. 1A and 1B, in known blades, such as blade 10 the cutting teeth 100A et seq. are disposed around the perimeter of the blade and each cutting tooth 100 has a front face with one or more Polycrystalline Diamond Compacts (PDCs) 120, at the upper edge as cutting elements, and a hardened front surface, such as a carbide plate 122. Each tooth 100 is retained in a seat on the saw blade 100 by welding or by another suitable retention system, as is known to those of skill in the art.

Cobbled soil contains small rocks of various sizes that are mixed in with the soil. Some ground cutting equipment does not perform satisfactorily as it must be operated at slower speeds or can be damaged or wear quickly due to the presence of cobbles. The term “cobble” may also be used to refer to areas where a microtrench must be cut through rock or other hard surfaces as opposed to soil or existing infrastructure of the usual type. Similar issues are encountered in cutting ground with concrete layers or fragments. Such surfaces can be more difficult to cut, resulting in more rapid wear on a saw blade or difficulties in microtrench formation.

Improved teeth for microtrencher saws and improved microtrencher saw blades for use in cobbled soils or for slicing concrete that have increased cutting and wear characteristics would be an improvement in the art.

### SUMMARY

The present disclosure is directed to systems and apparatus for improved cutting of microtrenches. In a first illustrative embodiment, a tooth for use on a disk shaped microtrenching saw blade has a body with a front or cutting face. Series of superhard cutting elements are disposed along the opposite side edges of the front face around a hardened front surface, such as a carbide plate, and one or more superhard cutting elements may be disposed along the upper edge. As the saw blade is rotated, the ground being cut by the tooth is initially contacted by the cutting elements prior to the remainder of the face, especially the side edges. In some embodiments, the upper edge of the front face may be inset at each side from the lateral edge of the face, such that the upper edge has a narrower cutting area with superhard cutting elements disposed thereacross. The present disclosure also includes embodiments of microtrenching saw blades including these novel teeth.

In another illustrative embodiment, a tooth for use on a disk shaped microtrenching saw blade has a body with a front or cutting face. A series of superhard cutting elements are disposed along the front face of the body, including at the upper edge and the opposite side edges to form a hardened front surface, such that as the saw blade is rotated, the ground being cut by the tooth is initially contacted by the cutting elements prior to the remainder of the tooth body. In some embodiments, the upper edge of the front face may be inset at each side from the lateral edge of the face, such that the upper edge has a narrower cutting area with superhard cutting elements disposed thereacross. The present disclosure also includes embodiments of microtrenching saw blades including these novel teeth.

### DESCRIPTION OF THE DRAWINGS

It will be appreciated by those of ordinary skill in the art that the various drawings are for illustrative purposes only. The nature of the present disclosure, as well as other varying embodiments, may be more clearly understood by reference to the following detailed description, and to the drawings, as well as to the appended claims.

FIG. 1A is a front perspective view of a known tooth for a microtrencher saw blade.

FIG. 1B is a top perspective view of a portion of a known microtrencher saw blade utilizing the known tooth of FIG. 1A.

FIGS. 2A, 2B, 2C are front perspective views of three different illustrative embodiments of cutting teeth for a microtrencher saw blade in accordance with the present disclosure.

FIG. 2D is a front view of another illustrative embodiment of a cutting tooth for a microtrencher saw blade in accordance with the present disclosure.

FIG. 3A is a front perspective view of a second illustrative embodiment of a cutting tooth for a microtrencher saw blade in accordance with the present disclosure.

FIG. 3B is a top perspective view of a portion of a microtrencher saw blade utilizing the tooth of FIG. 3A.

FIG. 4 is a front perspective view of a third illustrative embodiment of a cutting tooth for a microtrencher saw blade in accordance with the present disclosure.

FIGS. 5A and 5B are [a] front perspective and front views of a fourth type of illustrative embodiment of a cutting tooth for a microtrencher saw blade in accordance with the present disclosure.

FIG. 6 is a front perspective view of a fifth illustrative embodiment of a cutting tooth for a microtrencher saw blade in accordance with the present disclosure.

### DETAILED DESCRIPTION

The present disclosure relates to systems, methods and apparatus for improved cutting of microtrenches in rocky or cobbled soil or when encountering concrete layers or fragments with a ground cutting machine. It will be appreciated by those skilled in the art that the embodiments herein described, while illustrating certain embodiments, are not intended to limit the disclosure. Those skilled in the art will also understand that various combinations or modifications of the embodiments presented herein can be made without departing from the scope of this disclosure and that all such alternate embodiments are within the scope of this description. Similarly, while the drawings depict illustrative embodiments of the devices and components illustrate the principles upon which those devices and components are based, they are only illustrative, and any modifications of the features presented here are to be considered within the scope of this disclosure.

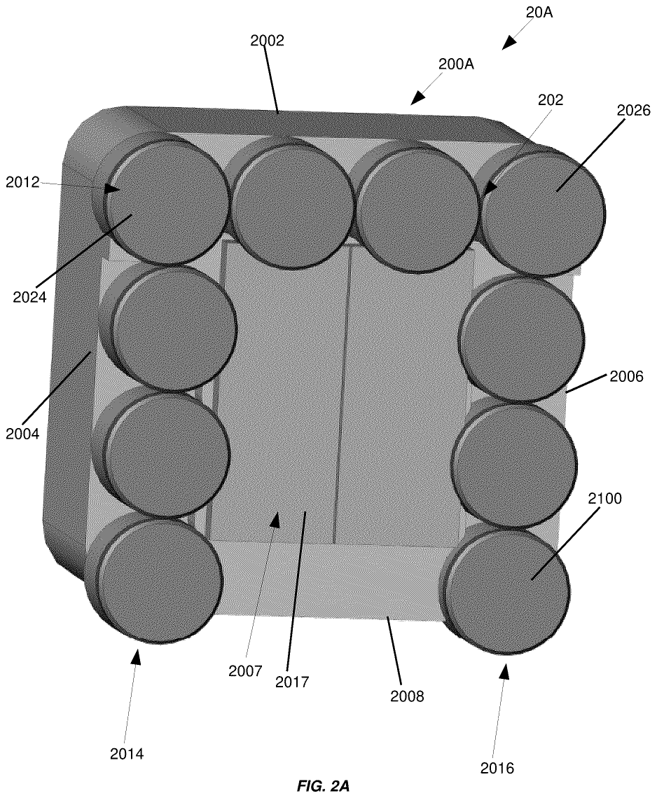

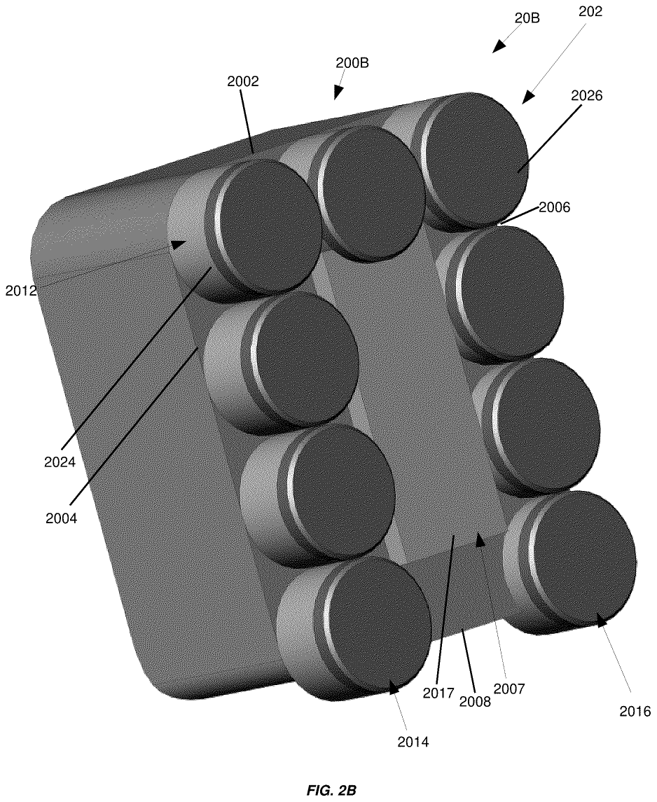

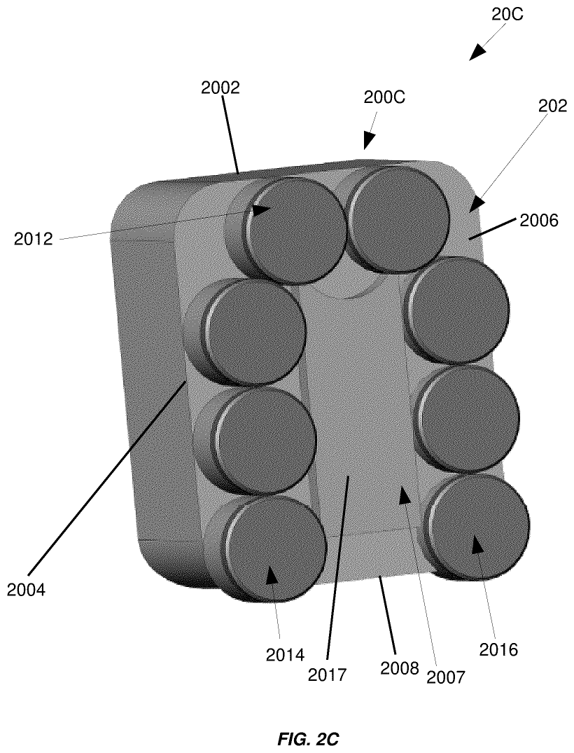

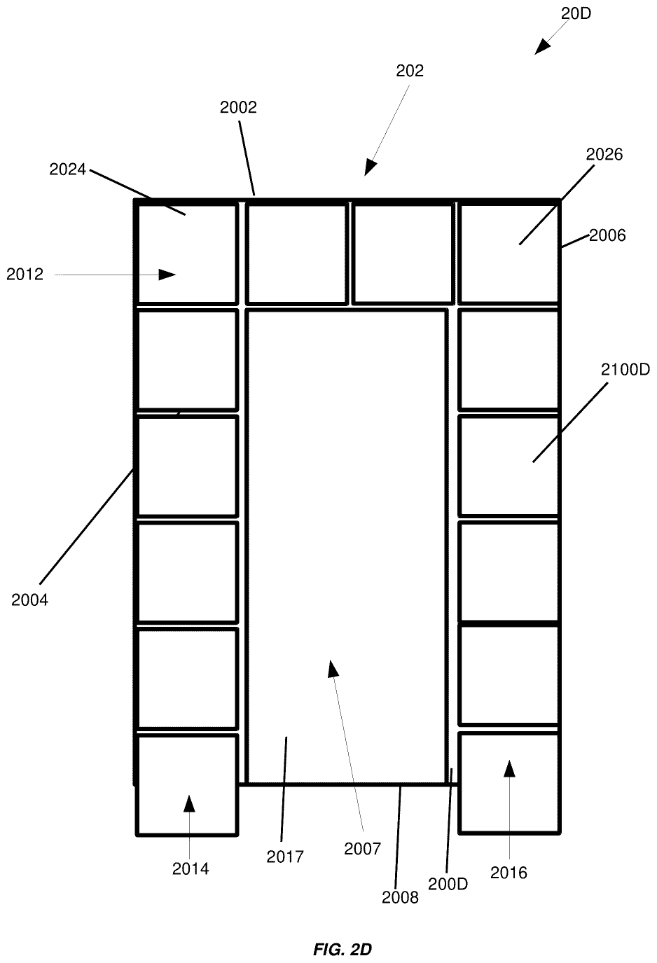

Turning to FIGS. 2A, 2B, 2C and 2D, four illustrative embodiments of teeth 20A, 20B, 20C and 20D for use on a disk shaped microtrenching saw blade are depicted. Common elements of these embodiments will be indicated with the same reference numerals for clarity. These may be differently sized and design embodiments for use on microtrenching saw blades that are intended for use in different conditions or for creating different sized or shaped micro trenches. For example, the teeth 20B and 20C may have a width of about 1.5 inches and teeth 20A and 20D may have widths of about 2.0 inches for cutting microtrenches of different sizes for placement of different utility lines.

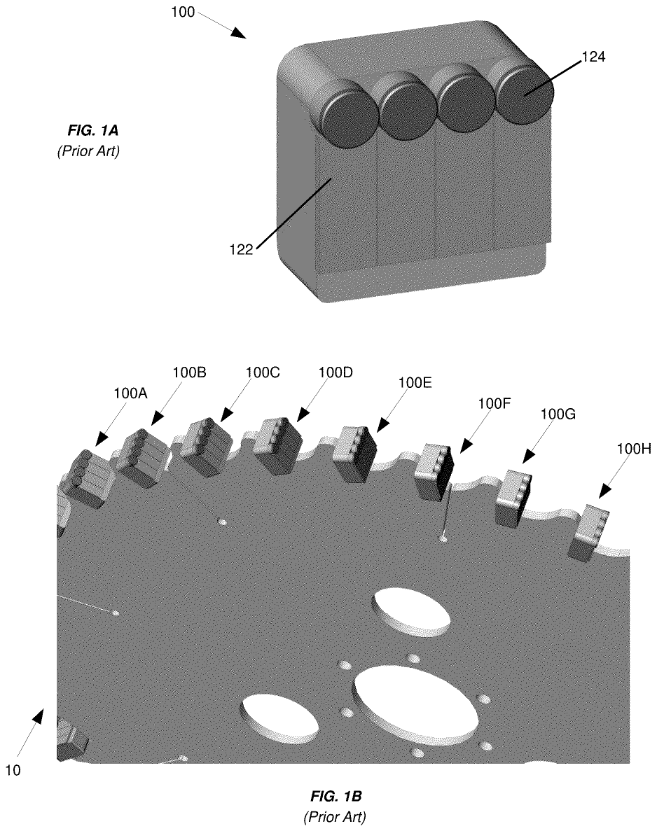

Teeth 20A, 20B, 20C and 2D are formed of bodies 200A, 200B, 200C and 200D which are each configured for attachment to a disk-shaped saw body similar to that depicted in FIG. 1B in a known manner as by welding in a seat formed on the saw body. In the depicted embodiment, each body 200A, 200B, 200C or 200D is formed as a generally rectangular block that fits in a corresponding seat on saw blade for use. It will be appreciated that where the seat of the saw blade has a different shape, that the corresponding portions of the body, such as the rear and bottom surfaces, may have corresponding shapes to allow for attachment to the seat. With the depicted embodiments, the bodies 200A, 200B, 200C, and 200D are typically joined to the seat by welding but it will be appreciated that other suitable joining methods known to those in the art may be used. Each body 200A, 200B, 200C, or 200D may be formed from any suitable material that can support the tooth components for use, including hardened steel materials.

Each tooth body 200A, 200B, 200C, or 200D has a front face 202 which is defined between an upper side 2002, lower side 2008 and opposite lateral sides 2004 and 2006. As depicted, front face 202 may be generally planar. A series of superhard cutting elements 2100 are disposed along at the upper edge and opposite side edges of the front face in linear sets. As depicted in FIGS. 2A, 2B and 2C, one suitable superhard cutting element that may be used are commercially available Polycrystalline Diamond Compacts (PDCs) as depicted with a rounded shape which may be welded, brazed or otherwise attached to the front face 202. It will be appreciated that other superhard cutting elements including polycrystalline diamond elements having other shapes (such as square, rectangular or other polygons), cutting elements formed of CBN materials or other superhard materials, or the like may be used. In FIG. 2D, generally square-shaped super hard cutting elements 2100D are depicted. It will be appreciated that where polygonal elements are used, they may be placed in adjacent positions to provide complete or near complete coverage of the face at the adjacent side edge.

In each of the depicted embodiments, there is an upper set 2012 of cutting elements disposed along the face at upper side 2002, and two side sets 2014 and 2016 of cutting elements disposed along the face along the two lateral sides 2004 and 2006. As depicted in teeth 20A, 20B and 20D, at the two upper corners cutting elements 2024 and 2026 are commonly shared between the upper and side linear sets. By contrast, tooth 20C has three separate linear sets.

Front face 202 further includes a hardened front surface 2007 in the space defined by the sets of cutting elements. Hardened front surface 2007 may be defined by one or more carbide plates 2017 disposed on the face using a suitable attachment.

As a saw blade containing tooth 200A, 200B, 200C or 200D is rotated for use, the ground being cut by the tooth is initially contacted by the sets of cutting elements along each of the upper and lateral surfaces, prior to the contact occurring along the remainder of the face 202 and the tooth. This results in improved cutting and an extended wear time before the tooth 200A, 200B, 200C or 200D must be replaced.

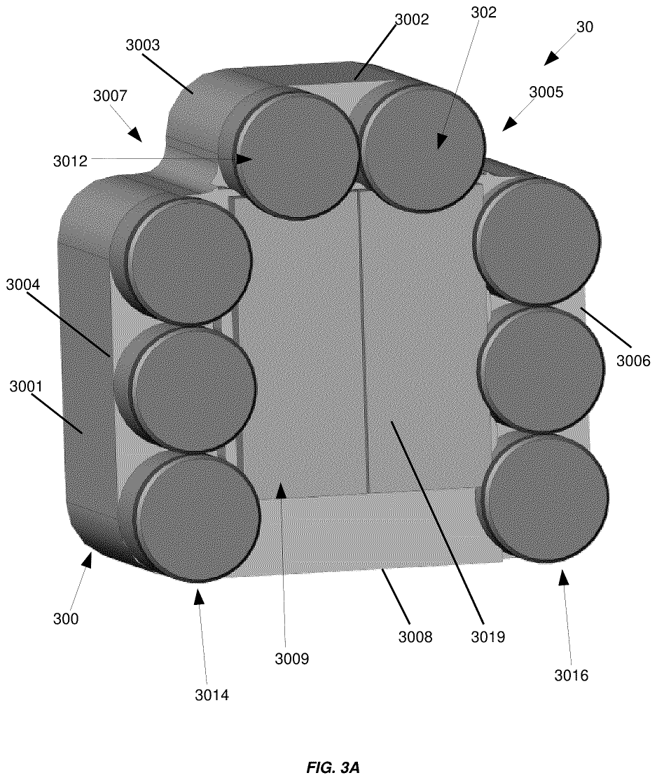

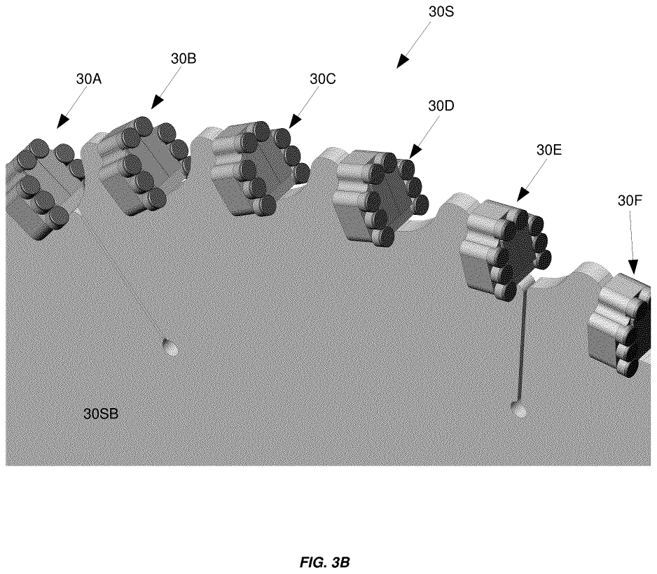

Turning to FIGS. 3A and 3B, another embodiment of a tooth 30 for use on a disk shaped microtrenching saw blade similar to that depicted in FIG. 1B is depicted. Tooth 30 is similar to tooth 20 discussed previously herein, with improved wear from having the upper edge of the front face inset at each side from the lateral edge of the face, such that the upper edge has a narrower cutting area with superhard cutting elements disposed thereacross.

As depicted, tooth 30 is formed of a body 300 which is configured for attachment to a disk-shaped saw body in a known manner as by welding in a seat formed on the saw body. In the depicted embodiment, body 300 is formed as a block with a generally rectangular lower portion and a smaller upper portion. Body 300 is configured to fit in a corresponding seat on saw blade for use, for example by having flat rear and bottom surfaces for welding to a rectangular receiving seat. It will be appreciated that where the seat of the saw blade has a different shape, that the corresponding portions of body 300, such as the rear and bottom surfaces, may have corresponding shapes to allow for attachment to the seat. With the depicted embodiment, the body 300 is typically joined to the seat by welding but it will be appreciated that other suitable joining methods known to those in the art may be used. Body 300 may be formed from any suitable material that can support the tooth components for use, including hardened steel materials.

Tooth body 300 has lower portion 3001 and a narrower upper portion 3003. Front face 302 of the tooth body 300 is defined between an upper side 3002, lower side 3008 and opposite lateral sides 3004 and 3006. As depicted, front face 302 may be generally planar. A series of superhard cutting elements are disposed along at the upper edge and opposite side edges of the front face in linear sets. One suitable superhard cutting element that may be used are commercially available Polycrystalline Diamond Compacts (PDCs) as depicted with a rounded shape which may be welded, brazed or otherwise attached to the front face 302. It will be appreciated that other superhard cutting elements including polycrystalline diamond elements having other shapes, cutting elements formed of CBN or other superhard materials, or the like may be used.

In the depicted embodiment, there is an upper set 3012 of cutting elements disposed along the face at upper side 3002 at upper portion 3003, and two side sets 3014 and 3016 of cutting elements disposed along the face along the two lateral sides 3004 and 3006 of the lower portion 3001. As depicted, the upper portion 3003 is inset at each lateral side from lower portion 3001 at each side edge to define a narrower cutting area. Each inset 3005 and 3007 may have a height and width generally corresponding to that of a cutting element. In the depicted embodiment, each inset 3005 and 3007 is formed through an entire length of the tooth body 300 from front face 302 to the rear of the body.

Front face 302 further includes a hardened front surface 3009 in the space defined by the sets of cutting elements and across the front of the lower portion 3001. Hardened front surface 3009 may be defined by one or more carbide plates 3019 disposed thereon.

FIG. 3B depicts a saw blade 30S having a series of teeth 30A, 30B, 30C, 30D, 30E, and 30F, et seq., as installed in thereon. Each tooth 30 is retained in a seat on the saw blade body 30SB by welding or by another suitable retention system, as is known to those of skill in the art. Although only a portion of saw blade 30S is depicted, saw blade body 30 SB is formed as a large disk having a series of seats disposed around its perimeter, for retaining teeth 30 for use. Additional structures for attachment of the saw to a microtrencher for rotation and use are formed in or attached to the blade body, such as a central passage for insertion of hub and holes for the insertion of securing bolts, as is known in the art.

As a saw blade containing tooth 300 is rotated for use, the ground being cut by the tooth 300 is initially contacted by the sets of cutting elements along each of the upper and lateral surfaces, prior to the contact occurring along the remainder of the face 302 and the tooth 300. This results in improved cutting and an extended wear time before the tooth 300 must be replaced. In use, applicant has found that a tooth 300 having inset upper portion 3003 has reduced wear compared to embodiments similar to that depicted in FIG. 2, by the elimination of the body material and cutting elements that shared between linear sets.

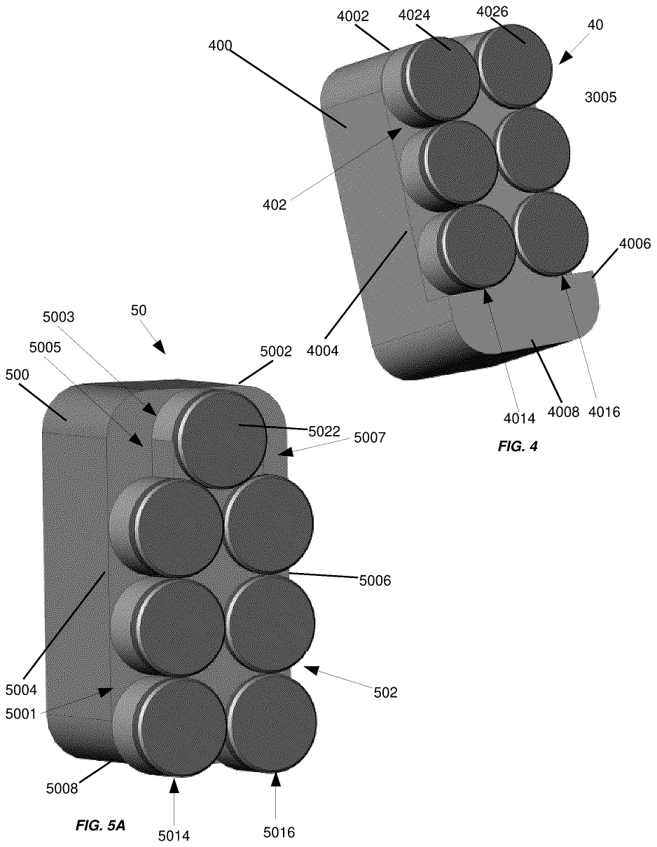

Turning to FIG. 4, another illustrative embodiment of a tooth 40 for use on a disk shaped microtrenching saw blade is depicted. Tooth 40 is formed of a body 400 which is configured for attachment to a disk-shaped saw body similar to that depicted in FIG. 1B in a known manner as by welding in a seat formed on the saw body. In the depicted embodiment, body 400 is formed as a generally rectangular block that fits in a corresponding seat on saw blade for use. It will be appreciated that where the seat of the saw blade has a different shape, that the corresponding portions of body 400, such as the rear and bottom surfaces, may have corresponding shapes to allow for attachment to the seat. With the depicted embodiment, the body 400 is typically joined to the seat by welding but it will be appreciated that other suitable joining methods known to those in the art may be used. Body 400 may be formed from any suitable material that can support the tooth components for use, including hardened steel materials.

Tooth body 400 has a front face 402 which is defined between an upper side 4002, lower side 4008 and opposite lateral sides 4004 and 4006. As depicted, front face 402 may be generally planar. A series of superhard cutting elements are disposed along at the upper edge and opposite side edges of the front face in linear sets. One suitable superhard cutting element that may be used are commercially available Polycrystalline Diamond Compacts (PDCs) as depicted with a rounded shape which may be welded, brazed or otherwise attached to the front face 402. It will be appreciated that other superhard cutting elements including materials including polycrystalline diamond elements having other shapes, cutting elements formed of CBN or other superhard materials, or the like may be used.

In the depicted embodiment, there are two parallel linear sets 4014 and 4016 of cutting elements disposed along the face along the two lateral sides 2004 and 2006. As depicted, at the upper end of the sets, the two cutting elements 4024 and 4026 are disposed along the commonly shared between the upper and side linear sets. As the two linear sets 4014 and 4016 are disposed adjacent to one another, they form a hardened front surface for the front face 402.

As a saw blade containing tooth 400 is rotated for use, the ground being cut by the tooth 400 is initially contacted by the sets of cutting elements along each of the upper and lateral surfaces, prior to the contact occurring along the remainder of the face 402 and the tooth 400. This results in improved cutting and an extended wear time before the tooth 400 must be replaced.

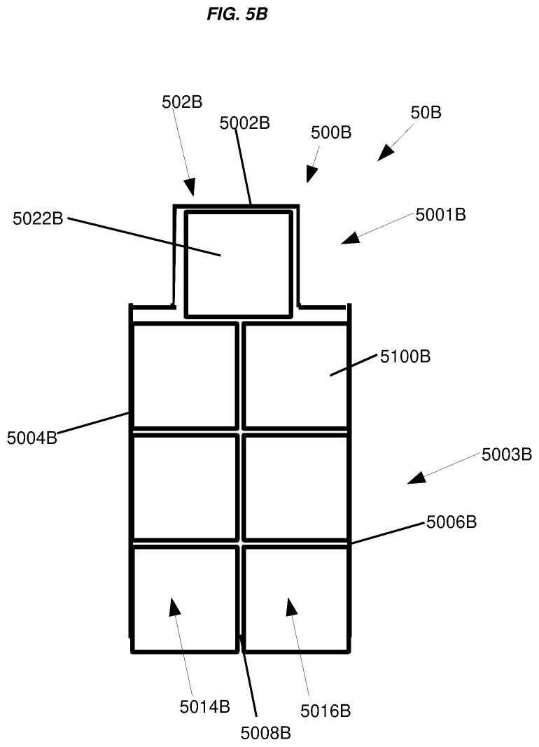

Turning to FIG. 5A, another embodiment of a tooth 50 for use on a disk shaped microtrenching saw blade similar to that depicted in FIG. 1B is depicted. Tooth 50 is similar to tooth 40 discussed previously herein, with improved wear from having the upper edge of the front face inset at each side from the lateral edge of the face, such that the upper edge of the front face has a narrower cutting area with superhard cutting elements disposed thereacross.

As depicted, tooth 50 is formed of a body 500 which is configured for attachment to a disk-shaped saw body in a known manner as by welding in a seat formed on the saw body. In the depicted embodiment, body 500 is formed as a block with a generally rectangular shape and shaped front face 502. Body 500 is configured to fit in a corresponding seat on saw blade for use, for example by having flat rear and bottom surfaces for welding to a rectangular receiving seat. It will be appreciated that where the seat of the saw blade has a different shape, that the corresponding portions of body 500, such as the rear and bottom surfaces, may have corresponding shapes to allow for attachment to the seat. With the depicted embodiment, the body 500 is typically joined to the seat by welding but it will be appreciated that other suitable joining methods known to those in the art may be used. Body 500 may be formed from any suitable material that can support the tooth components for use, including hardened steel materials.

A front face portion 502 is disposed at the front surface of the tooth body 500 and has a lower portion 5001 and a narrower upper portion 5003. Front face 502 of the tooth body 500 is defined between an upper side 5002, lower side 5008 and opposite lateral sides 5004 and 5006. As depicted, front face 502 may be generally planar. A series of superhard cutting elements are disposed along at the upper edge and opposite side edges of the front face in linear sets. One suitable superhard cutting element that may be used are commercially available Polycrystalline Diamond Compacts (PDCs) as depicted with a rounded shape which may be welded, brazed or otherwise attached to the front face 502. It will be appreciated that other superhard cutting elements including materials including polycrystalline diamond elements having other shapes, cutting elements formed of CBN or other superhard materials, or the like may be used.

In the depicted embodiment, there is an upper set consisting of a single centered cutting element 5022 disposed on the face at upper side 5002 at upper portion 5003, and two side sets 5014 and 5016 of cutting elements disposed along the face along the two lateral sides 5004 and 5006 of the lower portion 5001. As depicted, the upper portion 5003 of front face 502 is inset at each lateral side from lower portion 5001 (which extends across the entire front width of body 500) at each side edge to define a narrower cutting area. Each inset 5005 and 5007 may extend into the body 500 to a depth that prevents that portion of body 500 from contacting the ground during cutting prior to the cutting elements during use.

As the two linear sets 5014 and 5016 are disposed adjacent to one another and at their upper ends to top cutting element 5022, they form a hardened front surface for the front face 502. As a saw blade containing tooth 500 is rotated for use, the ground being cut by the tooth 500 is initially contacted by the sets of cutting elements along each of the upper and lateral surfaces, prior to the contact occurring along the remainder of the tooth 500. This results in improved cutting and an extended wear time before the tooth 500 must be replaced. In use, applicant has found that a tooth 500 having inset front face upper portion 5003 has reduced wear, by the elimination of the body material.

FIG. 5B depicts an embodiment of a tooth 50B similar to tooth 50 depicted in FIG. 5A, having generally square-shaped super hard cutting elements 5100B. It will be appreciated that where polygonal elements are used, they may be placed in adjacent positions to provide complete or near complete coverage of the face at the adjacent side edge.

As depicted, tooth 50B is formed of a body 500B which is configured for attachment to a disk-shaped saw body in a known manner as by welding in a seat formed on the saw body. In the depicted embodiment, body 500B is formed as a block with a generally rectangular shape and shaped front face 502B. Body 500B is configured to fit in a corresponding seat on saw blade for use, for example by having flat rear and bottom surfaces for welding to a rectangular receiving seat. It will be appreciated that where the seat of the saw blade has a different shape, that the corresponding portions of body 500B, such as the rear and bottom surfaces, may have corresponding shapes to allow for attachment to the seat. With the depicted embodiment, the body 500B is typically joined to the seat by welding but it will be appreciated that other suitable joining methods known to those in the art may be used. Body 500B may be formed from any suitable material that can support the tooth components for use, including hardened steel materials.

A front face portion 502B is disposed at the front surface of the tooth body 500B and has a lower portion 5001B and a narrower upper portion 5003B. Front face 502 of the tooth body 500 is defined between an upper side 5002B, lower side 5008B and opposite lateral sides 5004B and 5006B. As depicted, front face 502 may be generally planar. A series of superhard cutting elements 5100B are disposed along the opposite side edges of the front face in linear sets in the lower portion 5003B. A single superhard cutting element is depicted as disposed on the narrower upper portion 5001B. It will be appreciated that commercially available Polycrystalline Diamond Compacts (PDCs) may be used as the superhard cutting elements and may be welded, brazed or otherwise attached to the front face 502B. It will be appreciated that other superhard cutting elements including materials including polycrystalline diamond elements having other shapes, cutting elements formed of CBN or other superhard materials, or the like may be used.

In the depicted embodiment, there are two linear side sets 5014B and 5016B of cutting elements disposed along the face along the two lateral sides 5004B and 5006B of the lower portion 5001B. As depicted, the upper portion 5003B of front face 502B is inset at each lateral side from lower portion 5001B at each side edge to define a narrower cutting area. These insets extend through the entire body 500B.

As the two linear sets 5014B and 5016B are disposed adjacent to one another and at their upper ends to top cutting element 5022B, they form a hardened front surface for the front face 502B. As a saw blade containing tooth 50B is rotated for use, the ground being cut by the tooth 50B is initially contacted by the sets of cutting elements along each of the upper and lateral surfaces, prior to the contact occurring along the remainder of the tooth 50B. This results in improved cutting and an extended wear time before the tooth 50B must be replaced. In use, applicant has found that a tooth 50B having inset upper portion 5001B has reduced wear, by the elimination of the body material.

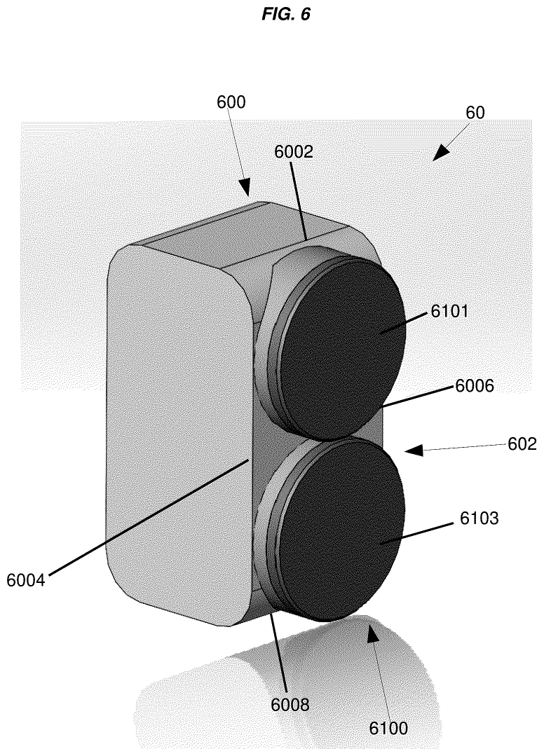

Turning to FIG. 6, another illustrative embodiment of a tooth 60 for use on a disk shaped microtrenching saw blade is depicted. Tooth 60 is formed of a body 600 which is configured for attachment to a disk-shaped saw body similar to those depicted in FIG. 1B or FIG. 3B in a known manner as by welding in a seat formed on the saw body. In the depicted embodiment, body 600 is formed as a generally rectangular block with rounded corners that fits in a corresponding seat on saw blade for use. It will be appreciated that where the seat of the saw blade has a different shape, that the corresponding portions of body 600, such as the rear and bottom surfaces, may have corresponding shapes to allow for attachment to the seat. With the depicted embodiment, the body 600 is typically joined to the seat by welding but it will be appreciated that other suitable joining methods known to those in the art may be used. Body 600 may be formed from any suitable material that can support the tooth components for use, including hardened steel materials.

Tooth body 600 has a front face 602 which is defined between an upper side 6002, lower side 6008 and opposite lateral sides 6004 and 6006. As depicted, front face 602 may be generally planar. A series 6100 of superhard cutting elements are disposed across the front face from the upper edge to the lower edge and from one opposite side edge to the other opposite side edge. As depicted the series may be a linear set. in the depicted embodiment, there are two superhard cutting elements 6101 and 6103. One type of suitable superhard cutting elements that may be used are commercially available Polycrystalline Diamond Compacts (PDCs) as depicted with a rounded shape which may be welded, brazed or otherwise attached to the front face 602. It will be appreciated that other superhard cutting elements including materials including polycrystalline diamond elements having other shapes, cutting elements formed of CBN or other superhard materials, or the like may be used.

In the depicted embodiment, there are two cutting elements 6101 and 6103 are disposed adjacent to one another and they form a hardened front surface for the front face 602. Covering the majority of the surface of the front face. 602. It will be appreciated that where polygonal cutting elements are used and placed adjacent one another, the entirety, or nearly all of the entirety of the face 602 may be covered.

As a saw blade containing tooth 600 is rotated for use, the ground being cut by the tooth 600 is initially contacted by the set of cutting elements, prior to the contact occurring along the remainder of the face 602 and the tooth 600. This results in improved cutting and an extended wear time before the tooth 600 must be replaced.

It will be appreciated that the superhard cutting elements that are commercially available as Polycrystalline Diamond Compacts (PDCs) are offered in a variety of sizes and have different shaped diamond faces. In constructing embodiments in accordance with the present disclosure, suitably sized PCD elements are selected to correspond to the size of the tooth and saw blade being manufactured. PDC elements having rounded, domed, flat, conical, parabolic, ridged (“axe”) and polygonal prismatic surfaces are available. Some of the depicted embodiments use rounded flat PDC elements and others use square flat shaped ones. It will be appreciated that where embodiments that use cutting elements having alternative shapes are contemplated, and that particular shapes maybe selected for use for blades designed to work in particular ground conditions.

While the disclosure has used the descriptions of certain embodiments to highlight inventive concepts, it will be appreciated such embodiments can be further modified within the spirit and scope of this disclosure. This application is therefore intended to cover any variations, uses, or adaptations of inventions in accordance with the disclosure using its general principles. Further, this application is intended to cover such departures from the present disclosure as come within known or customary practices in the art to which this invention pertains.

What is claimed is:

1. A tooth for a disk shaped microtrenching saw blade, comprising
a body with a front face;
a first linear series of superhard cutting elements disposed along a first lateral edge of the front face and covering a majority of the first lateral edge of the front face; and
a second linear series of superhard cutting elements disposed along a second lateral edge of the front face and covering a majority of the second lateral edge of the front face, such that as the saw blade is rotated, the ground being cut by the tooth is initially contacted by the linear sets of cutting elements.

2. The tooth of claim 1, wherein the front face further comprises a generally planar hardened front surface defined between the linear sets of superhard cutting elements.

3. The tooth of claim 1, wherein the hardened front surface comprises at least one carbide plate.

4. The tooth of claim 1, wherein the superhard cutting elements are polycrystalline diamond compacts.

5. The tooth of claim 4, wherein the polycrystalline diamond compacts have a flat cutting surface.

6. The tooth of claim 1, wherein the superhard cutting elements have a polygonal shape.

7. The tooth of claim 1, wherein an upper edge of the front face is inset at each side from the lateral edge of the front face, such that the upper edge has a narrower cutting area with at least one superhard cutting element disposed thereon.

8. The tooth of claim 7, wherein the inset at each side from the lateral edge of the front face comprises an inset at each side of the tooth body that is formed through an entire length of the tooth body from the front face to the rear of the tooth body.

9. The tooth of claim 1, further comprising a first linear series of superhard cutting elements disposed along an upper edge of the front face.

10. The tooth of claim 9, wherein the first linear series of superhard cutting elements and the third linear series of superhard cutting elements share a common superhard cutting element disposed at an upper corner of the front face.

11. The tooth of claim 1, wherein the first linear series of superhard cutting elements disposed along a first lateral edge of the front face and the second linear series of superhard cutting elements disposed along a second lateral edge of the front face are adjacent to one another and cover a majority of the front face.

12. A tooth for a disk shaped microtrenching saw blade, comprising a body with a front face;
a first linear series of superhard cutting elements disposed along an upper edge of the front face;
a second linear series of superhard cutting elements disposed along a first lateral edge of the front face; and
a third linear series of superhard cutting elements disposed along a second lateral edge of the front face, such that as the saw blade is rotated, the ground being cut by the tooth is initially contacted by the linear sets of cutting elements.

13. The tooth of claim 12, wherein the front face further comprises a generally planar hardened front surface defined between the linear sets of superhard cutting elements.

14. The tooth of claim 12, wherein the hardened front surface comprises at least one carbide plate.

15. The tooth of claim 12, wherein the cutting elements are polycrystalline diamond compacts.

16. The tooth of claim 15, wherein the polycrystalline diamond compacts have a flat cutting surface.

17. The tooth of claim 12, wherein the superhard cutting elements have a polygonal shape.

18. The tooth of claim 12, wherein an upper edge of the front face is inset at each side from the lateral edge of the front face, such that the upper edge has a narrower cutting area with superhard cutting elements disposed thereacross.

19. The tooth of claim 18, wherein the inset at each side from the lateral edge of the front face comprises an inset at each side of the tooth body that is formed through an entire length of the tooth body from the front face to the rear of the tooth body.

20. The tooth of claim 12, wherein the second linear series of superhard cutting elements disposed along a first lateral edge of the front face and the third linear series of superhard cutting elements disposed along a second lateral edge of the front face are adjacent to one another and cover a majority of the front face.

21. The tooth of claim 12, wherein the first linear series of superhard cutting elements and the second linear series of superhard cutting elements share a common superhard cutting element disposed at an upper corner of the front face.

22. A tooth for a disk shaped microtrenching saw blade, comprising a body with a front face;
a plurality of superhard cutting elements disposed on the front face adjacent to one another and covering a majority of the front face.

23. The tooth of claim 22, wherein the plurality of superhard cutting elements comprises one or more linear sets of superhard cutting elements.

24. The tooth of claim 22, wherein the cutting elements are polycrystalline diamond compacts.

25. The tooth of claim 24, wherein the polycrystalline diamond compacts have a flat cutting surface.

26. The tooth of claim 22, wherein the superhard cutting elements have a polygonal shape.

27. The tooth of claim 22, wherein the plurality of superhard cutting elements is disposed along a first lateral edge of the front face and along an opposite second lateral edge of the front face.
